(19) United States
(12) Patent Application Publication
(10) Pub. No.: US 2023/0396742 A1
(43) Pub. Date: Dec. 7, 2023

(54) LONG RANGE TARGET IMAGE RECOGNITION AND DETECTION SYSTEM

(71) Applicants: Nathaniel Joseph MCCANN, Port Orange, FL (US); Eugene Carroll CROUCH, Ormond Beach, FL (US); Robert J FITZSIMMONS, II, Deland, FL (US)

(72) Inventors: Nathaniel Joseph MCCANN, Port Orange, FL (US); Eugene Carroll CROUCH, Ormond Beach, FL (US); Robert J FITZSIMMONS, II, Deland, FL (US)

(21) Appl. No.: 18/450,810

(22) Filed: Aug. 16, 2023

Related U.S. Application Data
(63) Continuation of application No. 17/572,273, filed on Jan. 10, 2022, now abandoned.

(51) Int. Cl. H04N 7/18; G06V 20/40

(52) U.S. Cl. CPC H04N 7/181; G06V 20/42; G06V 2201/07

(57) ABSTRACT

Systems, methods, and computer programming products to provide real-time streaming of video content, hit indicators, and hit analytics from target locations to users, spectators, and certification authorities are provided. One embodiment includes a camera unit, configured to be directed at a target, to capture a stream of video content, and to transmit the stream of video content to a receiving unit and computing system. The computing system is configured to identify hit locations of projectiles on the target through optical processing of the stream of video content. The computing system is further configured to compute analytics pertaining to the detected hit locations on the target. Additionally, the computing system is configured to generate enhanced video content by indicating the location of the hit and/or computed analytics within the stream of video content and transmit the enhanced video content for display on one or more display devices.

### CROSS-REFERENCE TO RELATED APPLICATIONS

This application is a continuation of and claims priority to U.S. application Ser. No. 17/572,273, entitled “LONG RANGE TARGET IMAGE RECOGNITION AND DETECTION SYSTEM,” and filed Jan. 10, 2022, the entireties of which are hereby incorporated by reference.

### FIELD

An example embodiment of the present invention relates generally to the capture, transmission, processing, and presentation of streaming content, and more particularly to capturing video content at a target location, processing the video content to detect target hits, and presenting video content and hit analytics to end users, spectators, and certification agencies.

### BACKGROUND

Firing ranges are specialized indoor or outdoor venues that provide shooters a hands-on opportunity to safely practice the use of various types of firearms. Firing ranges vary in length from a few yards to a few miles. Firing ranges are often used to train and qualify individuals for specific uses of firearms in military, government, or private positions. These qualifications frequently require individuals to meet requirements for specific firearm certifications. Completing the certification process with the appropriate authority is often time consuming and cumbersome.

In addition, firing ranges also host competitions between multiple shooters which can be attended by spectators. Depending on the length of the firing range and the type of projectile, shooters and spectators can have difficulty seeing and determining if and where a target has been hit. Rapid determination of the location of a target hit can be important for calibrating a firearm, adjusting sights, and making other real-time adaptations. Further, rapid determination of the location of a target hit can be important for scoring and spectator visualization in a competition setting. These issues are exacerbated as the range length increases, as a long range may require a lengthy ride downrange to inspect the target.

Many solutions have been proposed to allow shooters to get real-time feedback of hit locations. Other solutions have used an array of microphones to capture the sound of an ultrasonic projectile as it passes to triangulate the position of the projectile. Still others have proposed the use of a system of lasers to create an assortment of light currents which are used to triangulate the position of a passing projectile. And some solutions, modify the target itself to splatter or change color upon impact to accentuate the location of the hit.

Applicant has identified a number of the deficiencies and problems associated with these other solutions including but not limited to: expensive and complicated setup, limitations on the types of targets to be used, limitations on setup location, and the inability to view live imagery of the target. Through applied effort, ingenuity, and innovation, Applicant has solved many of these identified problems by developing a solution that is embodied by the present invention, which is described in detail below.

### BRIEF SUMMARY

A system, method, and computer programming product are therefore provided according to example embodiments of the present invention to provide real-time content streaming systems delivering video content and hit indicators from target locations to users and spectators.

In one embodiment, a system is provided that includes at least one camera unit configured to be directed at a target and to capture a stream of video content and comprising a transmitting unit configured to transmit the stream of video content; a receiving unit configured to receive the one or more streams of video content from the at least one camera unit; and a computing system configured to receive the one or more streams of video content from the at least one receiving unit, wherein the at least one computing system comprises: a receiving module configured to receive the stream of video content from the one or more receiving units; a recognition module configured to receive the stream of video content from the receiving module and identify a hit location of a projectile on the target through optical processing of the stream of video content; a compute module, configured to compute analytics pertaining to the hit location of the projectile on the target; a rendering module configured to receive the stream of video content from the receiving module and generate enhanced video content by indicating the location of the hit and/or computed analytics within the stream of video content; and a transmit module configured to receive the enhanced video content from the rendering module and transmit the enhanced video content for display on a display device of a viewing station.

In some embodiments, the system may further comprise, a distribution unit configured to receive the one or more streams of enhanced video content from the computing system and transmit the one or more streams of enhanced video content to at least one viewing station and/or user control viewing station via a communication interface.

In some embodiments, the user control viewing station may comprise a display device configured to display the one or more streams of enhanced video content; and a control panel configured to allow control of the enhanced video content.

In some embodiments, the viewing station may comprise at least one display device configured to display the at least one stream of video content.

In some embodiments, the transmitting unit may be capable of wireless transmission and the receiving unit may be capable of receiving a wireless transmission.

In some embodiments, the receiving module may be configured to reduce noise on the stream of video content via a noise reducing algorithm.

In some embodiments, the receiving module may be configured to buffer the video content into a current frame and at least one previous frame.

In some embodiments, the current frame may be compared to the at least one previous frame to confirm uniformity of the hit location and to detect and disregard false hit detections arising from bugs, insects, animals, leaves, shadows, and/or other target anomalies.

In some embodiments, the recognition module may be configured to determine the likelihood of a hit based on the shape of the hit location.

In some embodiments, the recognition module may be configured to determine the size of the hit location on the current frame and compare the size of the hit location on the current frame with a stored standard size range.

In some embodiments, the recognition module may be configured to determine the color of the hit location on the current frame and compare the color of the hit location on the current frame with a stored standard color range.

In some embodiments, a bounding box may be automatically determined by the computing system through optical processing of the stream of video content to identify bounds of the target.

In some embodiments, the recognition module may be enabled and disabled manually through the user control viewing station or automatically through visual or auditory cues.

In some embodiments, the target may comprise a target identifier capable of uniquely identifying the target.

In some embodiments, a user may provide a user identifier capable of uniquely identifying the user.

In some embodiments, the target identifier, the user identifier, the hit location, and/or the computed analytics are stored in a storage device.

In another embodiment, a method is provided that at least comprises capturing, by a camera unit, video content of a projectile hitting a target; transmitting, by a transmitting unit, the captured video content; receiving, by a receiving unit, the captured video content; identifying, by a recognition module of a computing system, a hit location of the projectile on the target; computing, by a compute module of the computing system, analytics pertaining to the hit location of the projectile; and transmitting the current frame, hit location, and/or analytics for display on a display device of a viewing station.

In some embodiments, the method may further comprise buffering the video content, by the computing system, into a current frame and at least one previous frame.

In some embodiments, the transmitting unit may be a wireless data transmission device and the receiving unit may be a wireless data receiver, wherein transmitting the captured video content comprises wirelessly transmitting the captured video content, and wherein receiving the captured video content comprises wirelessly receiving the captured video content.

In some embodiments, identifying the hit location of the projectile on the target may further comprise identifying through optical processing of the stream of video content the hit location of the projectile at least based on the shape of the hit location.

In some embodiments, identifying the hit location of the projectile on the target may further comprise identifying through optical processing of the stream of video content the hit location of the projectile at least based on the color of the hit location.

In some embodiments, the method may further comprise comparing, by the recognition module, the hit location on the current frame of video with the same location on a previous frame of video to detect change and confirm the hit location.

In some embodiments, the method may further comprise identifying, by the recognition module, a target center.

In some embodiments, the method may further comprise computing, by the compute module, the distance from the hit location to the target center.

In some embodiments, the method may further comprise recording, by the computer system, the identified hit location in a hit progression sequence.

In some embodiments, the method may further comprise indicating, by the compute module, the hit progression sequence by marking the current frame.

In some embodiments, the method may further comprise saving to a database, by the computer system, the current frame containing the identified hit location.

In some embodiments, the method may further comprise providing an interface for displaying the current frame marked with the hit location on a viewing station.

In some embodiments, the method may further comprise identifying, by the compute module, a target identifier, capable of uniquely identifying the target.

In some embodiments, the method may further comprise storing, by the computer system, the target identifier, a user provided identifier capable of uniquely identify the user, the hit location, and/or the computed analytics in a storage device.

In another embodiment, a computer program product is provided for visually indicating the location of projectile hits, the computer program product comprising at least one non-transitory computer-readable storage medium having computer-executable program code instructions comprising program code instructions to: buffer video content, received as captured video content by a camera unit of a projectile hitting a target, into a current frame and at least one previous frame; perform image filtering to reduce noise on the current frame of video data; identify from the current frame of video data a hit location of the projectile on the target; identify a target center; compute analytics pertaining to the hit location of the projectile; provide an interface to a spectator for viewing the current frame, marked with the hit location and/or the analytics pertaining to the hit location of the projectile; and provide an interface to a user for viewing the current frame, marked with the hit location and/or the analytics pertaining to the hit location of the projectile.

In some embodiments of the computer program product, the video content may be wirelessly received from a wireless data transmission device.

In some embodiments of the computer program product, the hit location of the projectile may be identified at least in part based on the shape of the hit location.

In some embodiments of the computer program product, the hit location of the projectile may be identified at least in part based on the color of the hit location.

In some embodiments of the computer program product, the hit location may be identified at least in part based on comparing the hit location on the current frame of video with the same location on a previous frame of video to detect change and confirm a hit location.

In some embodiments of the computer program product, the marked current frame may indicate a progression of hit locations.

In some embodiments, the computer program product may be further configured to save to a database the current frame containing the identified hit location.

In some embodiments, the computer program product may be further configured to calculate the distance from the hit location to the target center.

In some embodiments, the computer program product may be further configured to record the identified hit location in a hit progression sequence.

In some embodiments, the computer program product may be further configured to identify on the target, a target identifier, capable of uniquely identifying the target.

In some embodiments, the computer program product may be further configured to store the target identifier, a user provided identifier capable of uniquely identify the user, the hit location, and/or the computed analytics in an accessible storage device.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 depicts a system for providing real-time, content streaming systems, delivering video content and hit indicators from multiple target locations to users and spectators in accordance with an example embodiment of the present invention.

FIG. 2 depicts a block diagram of a system for capturing video content from a target location, identifying target hits, and presenting video content through a viewing station.

FIG. 3 depicts a block diagram of a complete system for capturing video from a camera unit directed at a target location, identifying target hits, and presenting video content and hit indicators to users and spectators in accordance with an example embodiment of the present invention.

FIG. 4 depicts a block diagram representing a computing system, configured to process video content, recognize hit locations and target center locations, compute analytics based on hit and target center locations, and render video content containing indicators of detected hit locations in accordance with an example embodiment of the present invention.

FIG. 5 depicts a flowchart illustrating operations performed by a camera unit in accordance with an example embodiment of the present invention.

FIG. 6 depicts a flowchart illustrating operations performed by a receiving unit in accordance with an example embodiment of the present invention.

FIG. 7 depicts a flowchart illustrating operations performed by the computing system to process video content, identify hit locations, identify target features, calculate analytics, and indicate hit locations on video content in accordance with an example embodiment of the present invention.

FIG. 8 depicts a flowchart illustrating operations performed by the receiving module of the computing system, configured to process video content in preparation for hit detection in accordance with an example embodiment of the present invention.

FIG. 9 depicts a flowchart illustrating operations performed by the recognition module of the computing system, configured to determine hit locations in accordance with an example embodiment of the present invention.

FIG. 10 depicts a flowchart illustrating operations performed by the compute module of the computing system, configured to calculate hit location analytics in accordance with an example embodiment of the present invention.

FIG. 11 depicts a flowchart illustrating operations performed by the distribution unit, configured to receive and transmit video content as well as command and control commands, in accordance with an example embodiment of the present invention.

FIG. 12a-b are flow charts illustrating operations performed by the user control viewing station, in accordance with an example embodiment of the present invention.

FIG. 13 depicts a flowchart illustrating operations performed by the viewing station, configured to receive and display video content for onlookers, in accordance with an example embodiment of the present invention.

FIG. 14 illustrates an exemplary interface providing enhanced video content containing hit locations and other hit analytics in accordance with an example embodiment of the present invention.

### DETAILED DESCRIPTION

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

Embodiments of the present disclosure may be implemented, at least in part, as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Additionally, or alternatively, embodiments of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Systems, methods, and computer program products are provided according to example embodiments of the present invention to supply video content and hit indicators from target locations to users, spectators, and certification authorities. Depending on the length of a shooting range and the size of the projectile, shooters can have difficulty seeing and identifying hit locations on downrange targets. Rapidly determining the location of a target hit can be important in calibrating a firearm or other shooting device, adjusting sites, or making other real-time adjustments. In addition, many shooting competitions host spectators. In these situations, rapid identification of hit locations can aid in the calculation of real-time scores and improve the spectator experience. Finally, many ranges are used by law enforcement and other professionals requiring weapon certifications. For these professionals, providing weapon accuracy data to the governing agencies can be a long and cumbersome process. Many of the solutions in use require complicated setup, limit the types of targets that may be used, and/or restrict setup locations. Further, many of these solutions do not provide real-time, visual imagery of the target and hit locations. Even still, solutions in use do not make accuracy data and other analytics available to the necessary certification authorities.

Accordingly, various embodiments of the present disclosure make important technical contributions to the field of range targeting systems by improving the ease and flexibility with automated feedback systems while also improving the speed and quality of the associated feedback. Aspects of the present invention provide a simple and flexible system to supply valuable, real-time feedback to shooters and spectators. By utilizing the feedback provided by the present invention, shooters can make necessary adjustments and calibrations without costly disruptions. In addition, spectators can enjoy the real-time action and live scoring to enhance the overall spectator experience.

For example, various embodiments of the present invention utilize systems, methods, and computer program products to identify and mark target hit locations on video content transferred from target locations. In addition to marking hit locations, the present invention may calculate analytics related to hit locations to be presented to the shooter and spectators. These analytics may include but are not limited to distance from hit locations to the target center, the distance between a sequence of hits, shot grouping, hit progression, or other analytics indicative of a shooter's performance. Further, aspects of the present invention may upload this accuracy data and other analytics to storage accessible by certification authorities, aiding in the process of obtaining firearm certifications.

### Exemplary System Operations

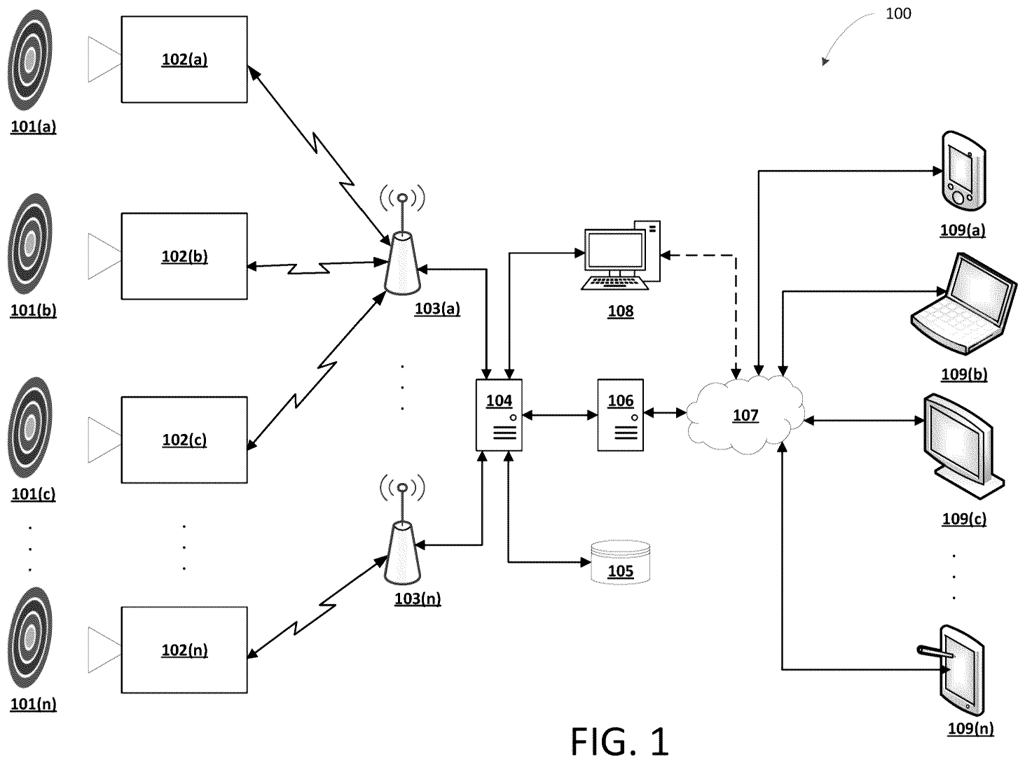

FIG. 1 illustrates an exemplary system for providing video content and hit indicators from target locations to users and spectators.

As illustrated in FIG. 1, a hit indicator system 100, may capture video content at one or more target 101 locations, transmit the video content to a receiving unit 103, process the video content at a computing system 104, transmit the video content and accompanying metadata to an optional distribution unit 106, and provide the content to a user control viewing station 108 and/or a viewing station 109 through a communication interface 107. In addition, a storage device 105 may be communicatively connected to the system configured to receive image content and user data from the computing system 104.

In some embodiments, the system may contain one or more targets 101a-n which can be any object placed as the aim of a shooter, archer, or other marksmen, intended to intersect the path of the incoming projectile. These targets may be made, for example, of paper, rubber, metal, straw, or any other material that will indicate the location of the intersecting projectile. A target may be designed to obstruct a projectile; catch or lodge a projectile; allow a projectile to puncture the target; or any other design that will allow the intersecting location to be indicated on the target.

In some embodiments, a target 101 may include an identifier capable of uniquely identifying the target. A target identifier may be, for example, a bar code, quick response (QR) code, machine readable label, universally unique identifier (UUID), proprietary identifier, or other means capable of identifying the target, whether uniquely and/or by type. In some embodiments, a recognition module 141 may perform optical processing operations on video content of the target to recognize and decode a target identifier. In some embodiments, a target identifier, along with a user identifier, hit locations, and/or other hit analytics for an identified session may be written to a storage device 105. In some embodiments, a storage device 105 may be accessible via direct connection or web interface to other entities, including law enforcement agencies or certification organizations. These other entities may access this data, for example, in support of certification, recertification, advancement, qualification, or other similar qualifying events. Allowing certification organizations and other entities to access automatically recorded data for a particular user may help to streamline these certification and qualification processes.

In some embodiments, one or more camera units 102a-n may be positioned and directed to capture video content of the one or more targets 101a-n. The camera units 102a-n may be positioned in any location to allow video content of the targets 101a-n and hit locations to be captured while still allowing discharged projectiles from the user station to intersect the target unimpeded. For example, in one embodiment, the camera unit 102 may be placed below the target, out of the line of sight of the incoming projectile, and directed up at the target in order to capture the target without impeding the path of the incoming projectile. In some embodiments, the camera units 102a-n may be shielded from the discharged projectiles by, for example, placing protective glass, steel, or other shielding material between the camera and the source of the incoming projectile but out of the trajectory of the incoming projectile. In other embodiments, the camera units 102a-n may be accompanied by lighting sources positioned to illuminate targets and hit locations. These lighting sources may project infrared light, visible light, ultraviolet light, or any other light beneficial in illuminating targets and projectile hit locations. In some embodiments, the camera units 102a-n may be fitted with filters designed to filter light from certain bandwidths to aid the camera units 102a-n in identifying targets 101a-n and projectile hit locations.

The hit indicator system 100 is illustrated to include a camera unit 102a-n encasing a transmitting unit 121; however, hit indicator systems 100 of the present embodiments may include transmitting units 121 housed separately from the camera unit 102a-n and communicatively connected to the camera unit 102a-n. In some embodiments, the transmitting unit 121 may be communicatively connected to a receiving unit 103 via a wired transmission protocol such as digital subscriber line (DSL), Ethernet, fiber distributed data interface (FDDI), or other wired protocol obvious to a person of ordinary skill in the art. In other embodiments, the transmitting unit 121 may be communicatively connected with a receiving unit 103 using a wireless transmission protocol obvious to a person of ordinary skill in the art.

A receiving unit 103 may refer to any device capable of receiving data from another unit or device. A receiving unit 103 may be placed any distance from a transmitting unit 121 at which the receiving unit 103 may remain in communicative connectivity with the transmitting unit 121. In some embodiments, this distance, for example, may be a few meters while in other embodiments, it may be a few miles. In some embodiments, a receiving unit 103 may receive encoded or encrypted data while in other embodiments a receiving unit 103 may receive raw data. In some embodiments a receiving unit 103 may use a wired transmission protocol such as digital subscriber line (DSL), Ethernet, fiber distributed data interface (FDDI) or any other wired protocol obvious to a person of ordinary skill in the art. In other embodiments, the receiving unit 103 may receive data using wireless transmission protocols such as Bluetooth protocols, IEEE 802.11 (Wi-Fi), or other wireless protocols for receiving data that are obvious to the person of ordinary skill in the art. In some embodiments, a hit indicator system 100 may contain one or more receiving units 103a-n. In such embodiments, each receiving unit 103 may be communicatively connected with one or more camera units 102. For example, a receiving unit 103 may be communicatively connected to group of camera units (e.g., 102a-102c) while a second receiving unit 103 may be communicatively connected to a second group of camera units (e.g. 102d-102n). In this example, each camera unit 102 would be communicatively connected to the computing system 104 and provide the stream of video content for each of the connected camera units 102.

The hit indicator system 100 as illustrated in FIG. 1 also contains a computing system 104 communicatively connected to the receiving unit 103. The computing system 104 may refer to any implementation of either hardware or a combination of hardware and software, capable of receiving and processing video content. In some embodiments, for example, the computing system 104 may be a standard personal computer (PC) or laptop.

The hit indicator system 100 depicts an optional distribution unit 106 communicatively connected to the computing system 104. The computing system 104 may be configured to provide video content and accompanying data to the distribution unit 106 which allows for the content and data to be distributed to a plurality of end-users. These end-users may be spectators viewing through one or more viewing stations 109a-n. The end-users may also include shooters, archers, or other marksmen viewing through one or more user control viewing stations 108. The optional use of a distribution unit 106 and communication interface 107 will allow end-users and spectators to view the video stream and accompanying hit indicators on a display device, for example, laptop, tablet, computer, or phone. In some embodiments, the distribution unit 106 may provide one or more communication interfaces 107 allowing end-users to select from one or more streams of video content with accompanying data. In the alternative, the computing system 104 may be communicatively connected directly to one or more viewing stations 108-109 to provide users and spectators with video content and accompanying data.

The hit indicator system 100 further depicts a user control viewing station 108. In some embodiments, the user control viewing station 108 may provide a display device 150, capable of displaying video content received from the computing system 104 or optionally the distribution unit 106. Some embodiments of the user control viewing station 108 may provide the user with a control panel 151 capable of controlling various aspects of the system. In some embodiments, the control panel 151 may be implemented as a user interface with selectable features, a separate device providing user selectable buttons (e.g., stream deck), and/or mechanical input (e.g., buttons, switches, etc.). In other embodiments, the user may provide a personal identifier or other universally unique identifier (UUID) at the user control viewing station 108 to uniquely identify the user, shooter, archer, or marksmen. A user may provide an identifier through a user interface, scanning device, optical processing, badge reader, or other similar means for obtaining a user specific identifier. A user identifier, along with a target identifier, hit locations, and/or shot analytics may be stored in a storage device 105, linking a unique user and/or session with the target, hit locations, and/or shot analytics. In some embodiments, a storage device 105 may be accessible via direct connection or web interface to other entities, including law enforcement agencies or certification organizations. These other entities may access this data, for example, in support of certification, recertification, advancement, qualification, or other similar qualifying events. Allowing certification organizations and other entities to access automatically recorded data for a particular user may help to streamline these certification and qualification processes.

The hit indicator system 100 further depicts a storage device 105. A storage device 105 may be any volatile or non-volatile media capable of storing visual imagery, such as a hard disk, solid-state storage, flash drive, compact disk, or the like. In some embodiments, a storage device 105 may be used to save imagery of hit locations, shot progressions, data analytics, and the like.

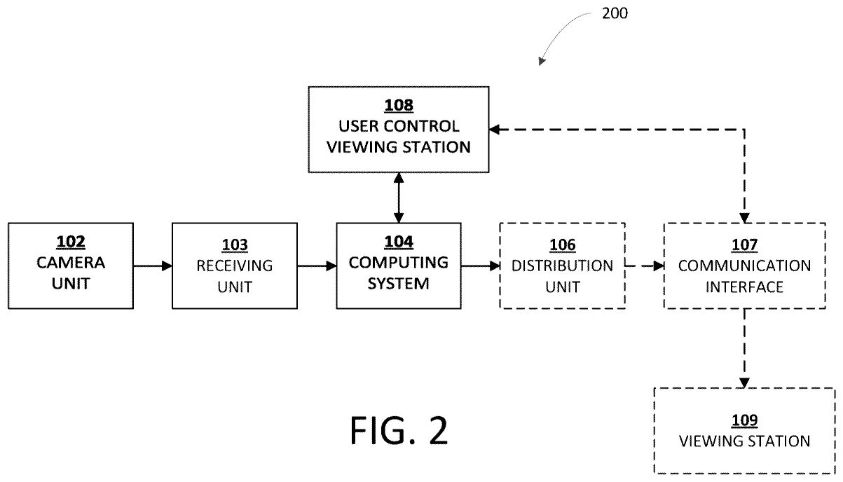

FIG. 2 depicts a block diagram of an example process 200 for detecting hit locations from a stream of video content of a target and providing the video content and hit locations, as well as additional statistics, to a plurality of end-users through a user control viewing station 108 and/or a viewing station 109. Process 200 depicts an embodiment in which video content is being captured and transmitted from one camera unit 102, however, hit indicator systems 100 of the present embodiments may include content captured and transmitted from a plurality of camera units 102.

The process 200 begins when a camera unit 102 begins to capture data of a target positioned to intersect projectiles discharged from a shooter or other user. In some embodiments, a camera unit 102 encases a transmitting unit 121 while in other embodiments, a transmitting unit 121 is housed separately. A camera unit 102 via a transmitting unit 121 transmits the captured video content to a receiving unit 103. In some embodiments, a transmitting unit 121 may be communicatively connected to a receiving unit 103 via a wired transmission protocol such as digital subscriber line (DSL), Ethernet, fiber distributed data interface (FDDI), or other wired protocol obvious to a person of ordinary skill in the art. In other embodiments, a transmitting unit 121 may be communicatively connected with a receiving unit 103 using a wireless transmission protocol such as Bluetooth, IEEE 802.11 (Wi-Fi), or other wireless protocol for sending/receiving data that are obvious to a person of ordinary skill in the art. In some embodiments, a camera unit 102 may include a video converter which may be used to compress/decompress video content, encode/decode video content, encrypt/decrypt video content, and so on.

The process 200 continues when a receiving unit 103 receives video content from a transmitting unit 121. A receiving unit 103 may be any device capable of receiving video content from a transmitting unit 121. A receiving unit 103 may be placed any distance from a transmitting unit 121 at which the receiving unit 103 may remain in communicative connectivity with the transmitting unit 121. In some embodiments, this distance, for example, may be a few meters while in other embodiments, it may be a few miles. In some embodiments, a receiving unit 103 may receive encoded or encrypted video content while in other embodiments a receiving unit 103 may receive raw data. In some embodiments a receiving unit 103 may use a wired transmission protocol such as digital subscriber line (DSL), Ethernet, fiber distributed data interface (FDDI) or any other wired protocol obvious to a person of ordinary skill in the art. However, in other embodiments, a receiving unit 103 may receive data using wireless transmission protocols such as Bluetooth protocols, IEEE 802.11 (Wi-Fi), or other wireless protocols for receiving data that are obvious to the person of ordinary skill in the art. In some embodiments, a receiving unit 103 may include a video converter which may be used to compress/decompress video content, encode/decode video content, encrypt/decrypt video content, and so on.

The process 200 continues when a computing system 104 receives the video content from a receiving unit 103. In some embodiments, a computing system 104 first receives video content via a receiving module 140 in preparation for identifying hit locations via a recognition module 141. In other embodiments, a computing system 104 may calculate analytics based on the detected hit location via a compute module 142. In still other embodiments, a computing system 104 may identify hit locations and hit analytics on video content via a rendering module 143. Embodiments of a computing system 104 may take the form of an entirely hardware embodiment, an entirely computer program product embodiment, and/or an embodiment that comprises a combination of computer program products and hardware, performing certain steps or operations. In some embodiments, the resulting enhanced video content contains indications of hit locations, the target center, and/or other hit analytics. These indications may be for example written directly on to the image data or provided in any data format (e.g. metadata) along with the video content.

The next step/operation in the process 200 occurs when the enhanced video content, including the associated data are sent to an optional distribution unit 106. In some embodiments, a distribution unit 106 may be configured at least to receive one or more video streams from a computing system 104 and transmit one or more video streams to a user control viewing station 108 and/or a viewing station 109 through a communication interface 107. A communication interface 107 may refer to any implementation of either hardware or a combination of hardware and software, communicatively coupled to a distribution unit 106 and configured to communicate with communication networks. In some embodiments, a distribution unit 106 may be configured to communicate with external communication networks and devices using a communication interface 107. A communication interface 107 may be configured to use a variety of interfaces such as data communication-oriented protocols, including X.25, ISDN, DSL, among others. A communication interface 107 may also incorporate a modem for interfacing and communicating with a standard telephone line, an Ethernet interface, cable system, and/or any other type of communications system. A user control viewing station 108 and/or viewing station 109 may access the video content through connection to the communication interface 107.

In some embodiments, utilization of a distribution unit 106 and a communication interface 107 may provide an interface for the selection of one of the one or more transmitted video streams to multiple users at user control viewing stations 108 and/or a viewing station 109. Users and spectators may be able to view the video stream and accompanying hit indicators on a display device, for example, laptop, tablet, computer, or phone. In some embodiments, a distribution unit 106 may provide one or more communication interfaces 107 allowing end-users to select from one or more streams of video content with accompanying data.

In some embodiments, access to a user interface may be provided through a machine-readable label, such as a barcode, Quick Response (QR) code, or similar mechanism. In other embodiments, the distribution may accept user input capable of controlling aspects of the computing system 104 and content of the provided video streams.

The next step/operation in process 200 occurs when a user or spectator interacts with the hit indicator system 100 through a user control viewing station 108 or viewing station 109. In the primary embodiment, a user control viewing station 108 is communicatively connected directly to a computing system 104. However, in other embodiments, a communication interface 107 may provide command and control operations to a user control viewing station 108. A user control viewing station 108 may refer to any device capable of providing commands to a computing system 104. In some embodiments, a user control viewing station 108 may also include a display, capable of displaying enhanced video content with accompanying data received from a computing system 104 directly or through a communication interface 107.

A viewing station 109 may refer to any device capable of communication with external communication networks and devices using a communication interface 107. In some embodiments, a user control viewing station 108 may provide a display, capable of displaying video content received from a distribution unit 106 through a communication interface 107. In other embodiments, viewing stations 109 may provide the user or spectator with an interface to control various aspects of the video content display through the communication interface 107. These controls may include but are not limited to selection of the specific video content stream, enabling/disabling the display of detected hits, enabling/disabling hit analytics, and so on.

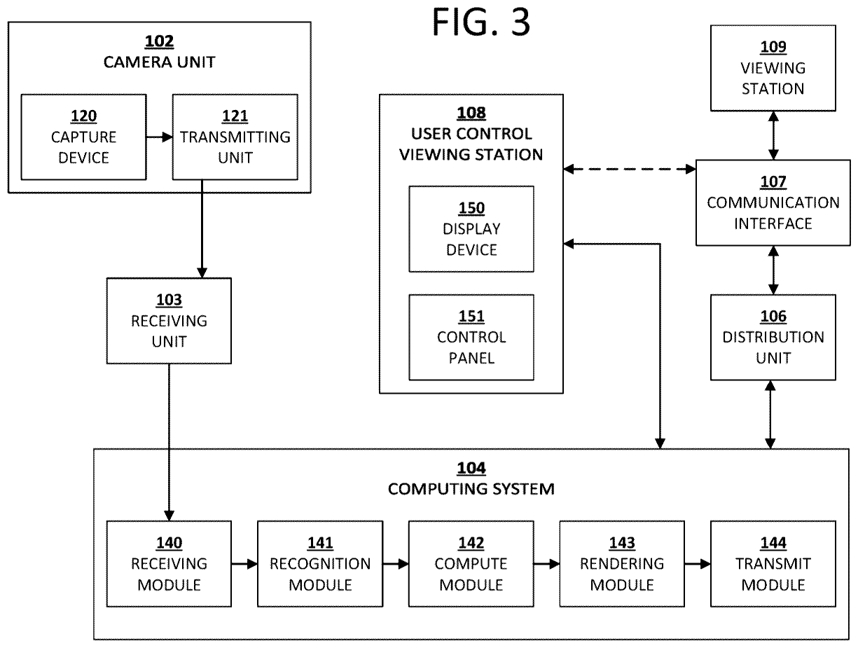

In some embodiments, a camera unit 102 of the hit indicator system 100 may perform steps/operations that correspond to the process depicted in FIG. 3. A camera unit 102 may refer to any device capable of capturing imagery or other visual representations of the targeted location. The camera unit 102 may be configured at least to capture video content, encode and buffer the captured content, and transfer video content to a transmitting unit 121. In some embodiments, the camera unit 102 may encase a capture device 120 and the transmitting unit 121. In other embodiments, the transmitting unit 121 may be housed separately from the camera unit 102.

A transmitting unit 121 may refer to any device capable of sending data to another unit or device. In some embodiments, a transmitting unit 121 may send encoded or encrypted data while in other embodiments a transmitting unit 121 may send raw data. In some embodiments, a transmitting unit 121 may use a wired transmission protocol such as digital subscriber line (DSL), Ethernet, fiber distributed data interface (FDDI) or any other wired protocol obvious to a person of ordinary skill in the art. In other embodiments, a transmitting unit 121 may send data using wireless transmission protocols such as Bluetooth protocols, IEEE 802.11 (Wi-Fi), or other wireless protocols for transmitting data that are obvious to the person of ordinary skill in the art.

In some embodiments, a computing system 104 of the hit indicator system 100 may perform steps/operations that correspond to the process depicted in FIG. 3. A computing system 104 may refer to any implementation of either hardware or a combination of hardware and software, communicatively coupled to a receiving unit 103, and capable of receiving and processing a stream of video content. In some embodiments, a computing system 104 may implement a receiving module 140, a recognition module 141, a compute module 142, a rendering module 143, and/or a transmit module 144. A computing system 104 may implement each of these modules on the same hardware and software system, or each module 140-144 may be implemented on a separate hardware and/or software system.

A computing system 104 may also provide an interface for control of the various sub-components by a user control viewing station 108, a viewing station 109, and/or through mechanical input. The interface to a computing system 104 may allow a user to control aspects of the computing system 104 including but not limited to enabling/disabling a receiving module 140, enabling/disabling the display of hit analytics, enabling/disabling the marking of hit locations, and so on. In other embodiments, the enabling/disabling of the listed features may be done through a distribution unit 106.

The process/operation of a computing system 104 may begin when video content is received by a receiving module 140. A receiving module 140 may refer to any implementation of either hardware or a combination of hardware and software, configured to receive and perform operations on video content. In some embodiments, a receiving module 140 may buffer the video content into frames. Buffered frames may be passed through processing steps or may be saved for comparison with other frames. In some embodiments, a receiving module 140 may perform a noise reduction algorithm such as a gaussian blur, median filter, adaptive filter, or any other noise reducing filter obvious to a person of ordinary skill in the art. Processed video content is transferred to a recognition module 141 for identification of the target and hit locations.

The next step/operation of computing system 104 may begin when video content is transferred from a receiving module 140 to a recognition module 141. A recognition module 141 may refer to any implementation of either hardware or a combination of hardware and software, communicatively coupled to a receiving module 140 and capable of receiving and performing operations on received video content. In some embodiments, a recognition module 141 may perform optical processing operations on video content to determine the location of hits on the target. For example, a recognition module 141 may perform an image difference between frames from dissimilar time instances to determine changes in the target of interest. Differences matching a projectile hit may be classified as a potential location of projectile hits. In addition, in some embodiments, a recognition module 141 may analyze the shape of potential locations of projectile hits to determine if the detected hit is consistent with the predetermined shape of projectile hits for the particular projectile. For example, the embodiment may determine the aspect ratio of the potential hit to determine its shape for comparison to the known shape of a hit for the particular projectile. In other embodiments, the recognition module 141 may analyze the shape of a potential hit against a specific shape by using edge detection and a shape detection algorithm, such as a contour approximation, Hough Transform, or other similar algorithm known by a person of ordinary skill in the art. The shape of a potential projectile hit can then be compared to known shapes for the particular projectile. Further, in some embodiments a recognition module 141 may determine the real-world size of a potential hit and compare the size to a predetermined and known size for the particular projectile. For example, a recognition module 141 may determine the size in millimeters of a projectile hit on the target and compare the size of the hit to the known caliber of the projectile. Still, in other embodiments, a recognition module 141 may determine the color of a potential hit and compare the color to a predetermined and known color for the particular projectile. For example, a recognition module 141 could distinguish the color of a hole through the target by the dark color when compared to an insect, shadow, or marking on the surface of a target. Finally, in other embodiments, a recognition module 141 may periodically compare the confirmed hit location to the same location on previously saved images to detect any movements or changes in the determined hit location. In some embodiments, for example, when a potential hit location is confirmed based on shape, size, and color, a recognition module 141 could periodically compare the image containing the confirmed hit location with a buffered image from a fixed earlier time period (e.g., one second earlier). If the confirmed hit location has moved, or is now gone, a recognition module 141 can determine if the hit location is indeed legitimate. This comparison across time can eliminate false positive hit locations brought about by a number of hit detection issues, including the presence of insects and bugs on the target. Even still, in other embodiments, a recognition module 141 may use machine learning methods to recognize hit locations. The machine learning method utilized may consist of a supervised learning model, unsupervised learning model, reinforcement learning model, or other machine learning model that may be trained to recognize hit locations. In some embodiments, the model may be provided with training data containing identified hit locations for purposes of training the machine learning model. Still, in other embodiments, the machine learning model may be provided with feedback via a user or supervisor to train the machine learning model to recognize hit locations.

A recognition module 141 may also use image processing techniques to determine the center of a target 101 for purposes of calculating hit analytics by the compute module 142. A recognition module 141 may use all of the techniques listed above to determine the bounds and center of the target. These techniques may include, for example, edge detection and shape recognition; real-world size determination; and color analysis. In other embodiments, a user control viewing station 108 may provide an interface to manually indicate the center and/or features of the target. In still other embodiments, a recognition module 141 may accept indication of a target bounding box which limits a recognition module 141 to perform processing on the part or parts of the image indicated. The bounding box may be indicated through user input or determined automatically using image processing techniques discussed above. The identified hit locations and target identifiers are passed to a compute module 142 as recognition data.

In some embodiments, a recognition module 141 may be configured to enable and disable detection of projectile hit locations. In some embodiments, a recognition module 141 may be enabled and disabled manually through a user control viewing station 108 user interface (e.g., stream deck or Graphical User Interface (GUI)), through a mechanical interface to a recognition module 141, such as a switch, or even automatically by detecting some sort of trigger such as a sound or flash. In some embodiments, for example, a microphone or camera may be directed at the firing location. When a firearm is shot, the microphone or camera may be configured to detect the sound of the firearm or detect the firing of a shot through optical processing of the imagery. Once a shot is fired, a signal may be sent to a computing system 104 to enable a recognition module 141. This procedure prevents the recognition module 141 from processing unnecessarily, and may reduce false detections of hit locations that occur while shots are not being fired.

The next step/operation of the computing system 104 may begin when video content and recognition data are transmitted from a recognition module 141 to a compute module 142 to compute hit analytics. A compute module 142 may refer to any implementation of either hardware or a combination of hardware and software, communicatively coupled to a recognition module 141 and capable of receiving data and performing hit analytics on the detected hit locations. In some embodiments, a compute module 142 may calculate and save the distance from hit locations to the target center. In some embodiments, a compute module 142 may also calculate other analytics indicative of a shooter's performance. These analytics may include, for example, the distance between each hit in a sequence of hits, the maximum distance between any two projectile hits (shot grouping), or similar calculations. In other embodiments, a compute module 142 can calculate and track the hit progression from one hit to a subsequent hit. The hit analytics generated by a compute module 142 may then be transmitted, along with the video content and recognition data, to a rendering module 143.

The next step/operation of computing system 104 may begin when video content, recognition data, and hit analytics are transmitted from a compute module 142 to a rendering module 143. A rendering module 143 may refer to any implementation of either hardware or a combination of hardware and software, communicatively coupled to a compute module 142 and capable of receiving video content and performing operations on the content to prepare the content for display. In some embodiments, a rendering module 143 may identify the location of hits on the video content using text, graphics, or other markers based on the data received from a compute module 142. For example, by graphically drawing a circle or point at each hit location. In other embodiments, a rendering module 143 may overlay hit analytics on the video content, such as distance calculations, hit grouping, hit progression, and other analytics indicative of a shooter's performance using text, graphics, or other markers. In still other embodiments, a rendering module 143 may accept commands controlling the data to be overlayed on the video content. In still other embodiments, a rendering module 143 may format the compute and recognition data for transmission with the video stream. This data may be formatted in compliance with a metadata standard known to a person of ordinary skill in the art or in a custom format. A rendering module 143 may encode the formatted compute and recognition data in the stream of video content to be transmitted.

The final step/operation of a computing system 104 may begin when video content, recognition data, and hit analytics are transmitted from a rendering module 143 to a transmit module 144. A transmit module 144 may refer to any implementation of either hardware or a combination of hardware and software, communicatively coupled to a rendering module 143 and capable of transmitting video content to a distribution unit 106 or directly to a user control viewing station 108.

In some embodiments, a user control viewing station 108 of a hit indicator system 100 may perform steps/operations that correspond to the process depicted in FIG. 3. A user control viewing station 108 may refer to any device capable of communication with external communication networks and devices using the communication interface 107 or capable of sending command communication to a computing system 104 directly. In some embodiments, a user control viewing station 108 may provide a display device 150, capable of displaying video content received from either a distribution unit 106 through a communication interface 107 or received from a transmit module 144 of a computing system 104 directly. In some embodiments, for example, a display device 150, may be a computer monitor, laptop, table, phone, or other similar device. Some embodiments of a user control viewing station 108 may provide the user with a control panel 151. A control panel 151 may refer to any implementation of either hardware or a combination of hardware and software that provides an interface for the user to control various aspects of the system. In some embodiments, a control panel 151 may be configured to command and control various aspects of the system through a communication interface 107. These commands may include but are not limited to enabling/disabling the recognition module 141, enabling/disabling the display of detected hits, enabling/disabling hit analytics, manual selection of the bounds of the region of interest, enabling/disabling screenshot capture and save on detected hits, selection of video stream display, and so on. In some embodiments, a user control viewing station 108 may allow the user to provide a personal identifier to uniquely identify the user. A user may provide an identifier through a user interface, scanning device, optical processing, badge reader, or other similar means for obtaining a user specific identifier. A user or session identifier, along with a target identifier, hit locations, and/or shot analytics may be stored in a storage device 105, linking a unique user and/or session with a target, hit locations, and/or shot analytics. In some embodiments, these analytics may be provided to outside entities either directly or via web interface, to facilitate, for example, certification and qualification processes. In some embodiments, access to a user control viewing station 108 may be provided through a machine-readable label, such as a barcode, QR code, or similar mechanism. In some embodiments, a control panel 151 may be communicatively coupled to the computing system 104 directly, the distribution unit 106, and/or the communication interface 107. In some embodiments, the control panel 151 may be implemented, for example, as a user interface on a PC, tablet, or phone, with selectable features; a distinct device providing user selectable buttons (e.g., stream deck); and/or mechanical input (e.g., buttons, switches, etc.).

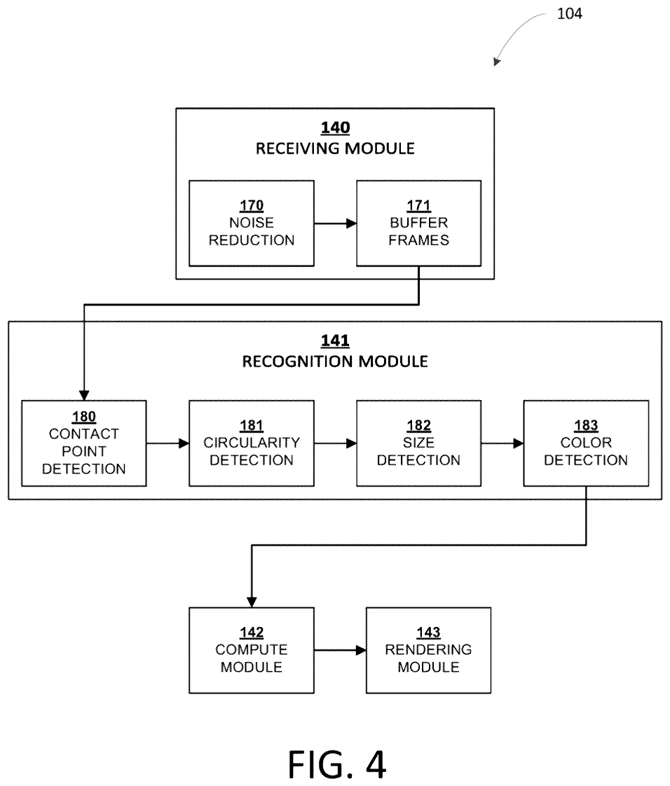

In some embodiments, a receiving module 140 of a computing system 104 may perform steps/operations that correspond to the process depicted in FIG. 4. In some embodiments, a receiving module 140 may perform a noise reduction algorithm via a noise reduction module 170 such as a gaussian blur, median filter, adaptive filter, or any other noise reducing filter obvious to a person of ordinary skill in the art. In other embodiments, a receiving module 140 may buffer the video content into frames via a buffer frames module 171. Buffered frames may be passed through processing steps or may be saved for comparison with other frames. For example, a buffer frames module 171 may continually buffer frames for one second to provide frames necessary for comparison in a recognition module 141. The processed video content is transferred to a recognition module 141 for identification of the target and hit locations.

In some embodiments, a recognition module 141 of the computing system 104 may perform steps/operations that correspond to the process depicted in FIG. 4. In some embodiments, a contact point detection module 180 may perform operations to detect the location of a projectile hit. For example, a recognition module 141 may perform an image difference between frames from dissimilar time instances to determine changes in the target of interest. Differences matching a projectile hit may be classified as a potential location of projectile hits. All potential hit locations are determined and transferred to the subsequent steps of the recognition module 141 for further evaluation.

In some embodiments, the shape detection module 181 may perform steps/operations to determine the shape of the detected contact point and compare the determined shape with the predetermined shape of projectile hits for the particular projectile. For example, the embodiment may determine the aspect ratio of the potential hit to determine if the shape of the potential hit corresponds with a known shape of a hit for the particular projectile. In other embodiments, the shape detection module 181 may analyze the shape of a potential hit against a specific shape by using edge detection and a shape detection algorithm, such as a contour approximation, Hough Transform, or other similar algorithm known by a person of ordinary skill in the art.

In some embodiments, a size detection module 182 may determine the real-world size of a potential hit and compare the size to a predetermined and known range of sizes for the particular projectile. For example, a size detection module 182 may determine the size in millimeters of a projectile hit on the target and compare the size of the hit to the known caliber of the projectile.

In some embodiments, a color detection module 183 may determine the color of a potential hit and compare the color to a predetermined and known range of colors for the particular projectile. For example, a color detection module 183 may distinguish the color of a hole through the target by the dark color when compared to an insect, shadow, or marking on the surface of a target.

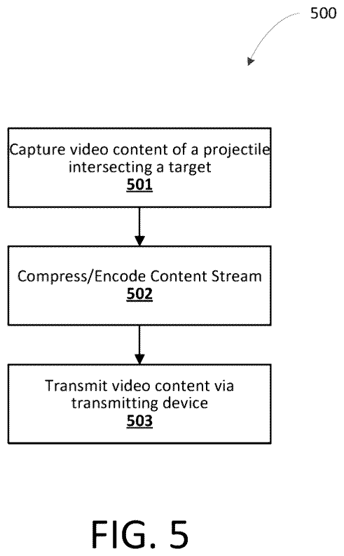

FIGS. 5 through 13 illustrate flow charts of operations which may be performed by a hit indicator system 100 in accordance with an example embodiment of the present invention.

FIG. 5 illustrates a flow chart of operations 500 which may be performed by a camera unit 102 in some embodiments. As shown in block 501, a camera unit 102 may include means to provide for capturing video content to be streamed. At block 502, a camera unit 102 may include means, such as a video converter/buffer, to encode, compress, and buffer the captured content. At block 503, a camera unit 102 may include means to cause an encoded content stream to be transmitted to a receiver such as receiving unit 103.

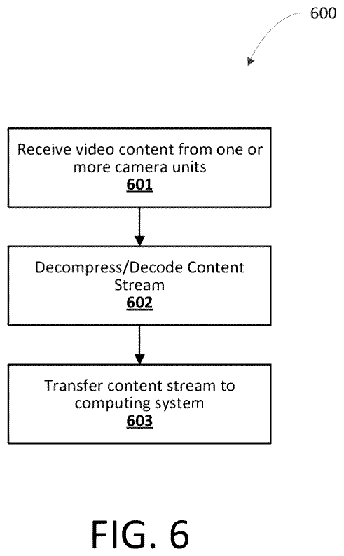

FIG. 6 illustrates a flow chart of operations 600 which may be performed by a receiving unit 103, in some embodiments. As shown in block 601, the receiving unit 103 may include means, such as a processor, communications interface, or the like, to receive one or more streams of content from one or more camera units 102. At block 602, a receiving unit 103 may include means, such as a processor, hardware, communications interface, or the like, to decode and/or decompress content streams received from the one or more camera units 102. At block 603, a receiving unit 103 may include means, such as a processor, memory, communications interface, or the like, to transfer the video content stream to a computing system 104.

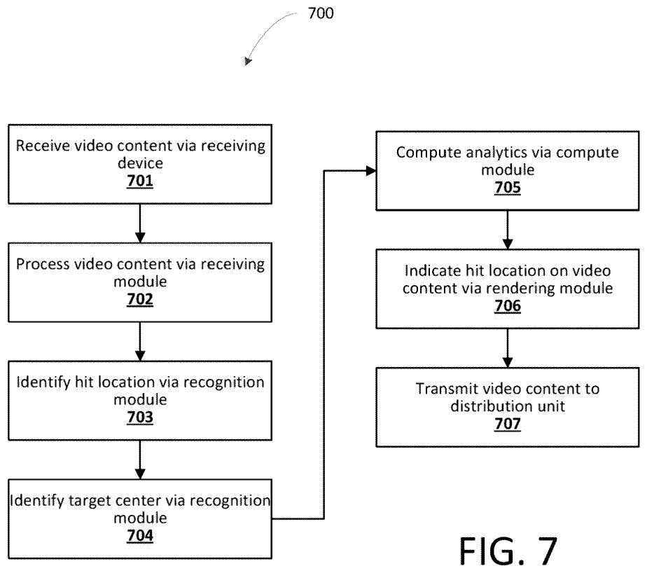

FIG. 7 illustrates a flow chart of operations 700 which may be performed by a computing system 104, in some embodiments. As shown in block 701, the computing system 104 may include means, such as a processor, communications interface, or the like, to receive video content from a receiving unit 103. As shown in block 702, the computing system 104 may include a receiving module 140 with means, such as a processor, memory, hardware, firmware, or the like to buffer, analyze, and manipulate video content to prepare video content for identification operations. As shown in block 703, the computing system 104 may include a recognition module 141 with means, such as a processor, memory, hardware, firmware, or the like, to identify the location of projectile hits in video content, other imagery, or through user input. As shown in block 704, a recognition module 141 may also be capable of identifying a target center based on video content, other imagery, or user input. As shown in block 705, the computing system 104 may include a compute module 142 with means, such as processor, memory, hardware, firmware, or the like, to compute analytics and other statistics based on hit locations. As shown in block 706, a computing system 104 may include a rendering module 143 with means, such as a processor, memory, or the like, to indicate hit locations, target features, statistical data, or other information on the accompanying video content. As shown in block 707, a computing system 104 may include means, such as processor, communications interface, hardware, firmware, or the like, to transmit video content to a distribution unit 106, user control viewing station 108, or viewing station 109.

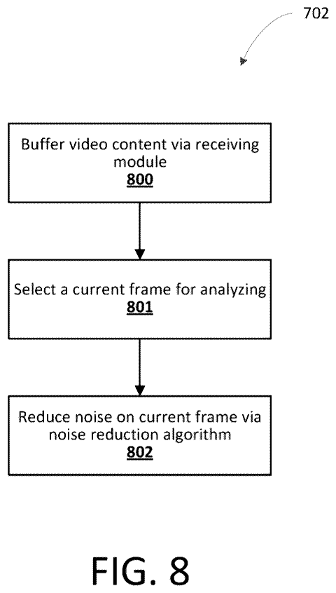

FIG. 8 illustrates a flow chart of operations which may be performed by a receiving module 140, according to the steps/operations of block 702, in some embodiments. As shown in block 800, a receiving module 140 may include means, such as a processor, memory, or the like to buffer video content. As shown in block 801, a receiving module 140 may include means, such as a processor, memory, user interface, or the like, to select a frame from the video content to be processed by a recognition module 141. As shown in block 802, a receiving module 140 may include means, such as a processor, memory, hardware, firmware, or the like to reduce noise in the video content and prepare imagery for a recognition module 141.

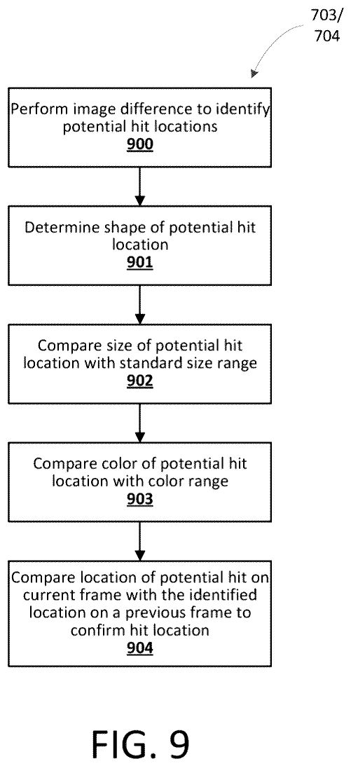

FIG. 9 illustrates a flow chart of operations which may be performed by a recognition module 141, according to the steps/operations of process 703/704, in some embodiments. As shown in block 900, a recognition module 141 may include means, such as a processor, memory, hardware, firmware, or the like, to perform an image difference to facilitate identification of potential hit locations. In some embodiments, an image difference operation may include comparing two images captured at distinct time slots to identify changes in the captured content. As shown in block 901, a recognition module 141 may include means, such as a processor, memory, hardware, firmware, or the like, to determine the shape of a potential hit location. In some embodiments, a recognition module 141 may determine the aspect ratio of a potential hit location and compare a determined aspect ratio to a known shape for a specific projectile. For example, the aspect ratio may be used to determine the circularity of a hit location and compare the determined circularity with the known shape of hit locations from the given projectile. In other embodiments, a recognition module 141 may analyze the shape of a potential hit against a specific shape by using edge detection and a shape detection algorithm, such as a contour approximation, Hough Transform, or other similar algorithm known by a person of ordinary skill in the art. In some embodiments, the shape of a potential projectile hit may be compared to known shapes for the particular projectile.

As shown in block 902, a recognition module 141 may determine the size of the potential hit location and compare the determined size to a pre-determined size range for the specific projectile and/or target. For example, a recognition module 141 may determine the size in millimeters of a projectile hit on the target and compare the size of the hit to the known caliber of a given projectile. As shown in block 903, the recognition module 141 may include means, such as a processor, memory, hardware, firmware, or the like, for determining the color or shading of a potential hit location for purposes of comparing the determined color or shading with a determined color range. In some embodiments, for example, a recognition module 141 could distinguish the color of a hole through the target by identifying a darker black color when compared to an insect, shadow, or marking on the surface of a target which may be brown, gray, or a lighter shade of black. As shown in block 904, the recognition module 141 may compare the location of a potential hit on the currently processed frame with the same location on a frame from a previously distinct time in order to determine the likelihood of a projectile hit. In some embodiments, the comparison is analyzed to determine if the hit location has changed shapes or moved in the interim time period. In some embodiments, for example, when a potential hit location is confirmed based on shape, size, and color, a recognition module 141 may periodically compare the image containing the confirmed hit location with a buffered image from a fixed earlier time period (e.g., one second earlier). If the confirmed hit location has moved, or is now gone, a recognition module 141 may determine the hit location was illegitimate. This comparison across time may eliminate false positive hit locations brought about by a number of hit detection issues, including the presence of insects and bugs on the target, shadows, debris, and the like.

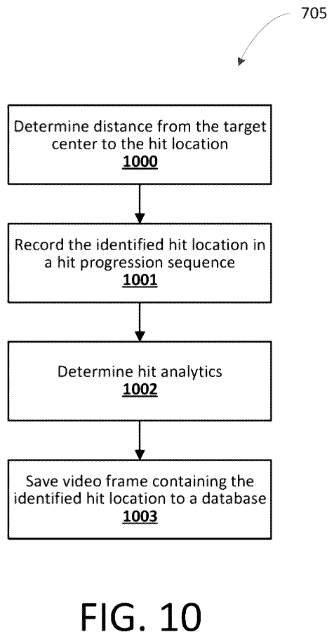

FIG. 10 illustrates a flow chart of operations which may be performed by a compute module 142, according to the steps/operations of block 705, in some embodiments. As shown in block 1000, a compute module 142 may include means, such as a processor, memory, hardware, firmware, or the like, to determine the distance from the target center to the determined hit location. As shown in block 1001, a compute module 142 may include means, such as a processor, memory, or the like, to record the detected hit location in a hit progression sequence. As shown in block 1002, a compute module 142 may include means, such as a processor, memory, or the like, to determine hit analytics based on the identified hit location. These analytics may include but are not limited to the distance from hit locations to a target 101 center, the distance between a sequence of hits, the maximum distance between two shots in a shot sequence (e.g., shot grouping), hit progression statistics, or other analytics indicative of a shooter's performance or of interest to onlookers. As shown in block 1003, a compute module 142 may include means, such as a processor, memory, or the like, to save video frames containing the identified hit location to a memory store, such as a database. Saving video frames based on an identified hit location may be initiated automatically, via setting, through user input, or the like.

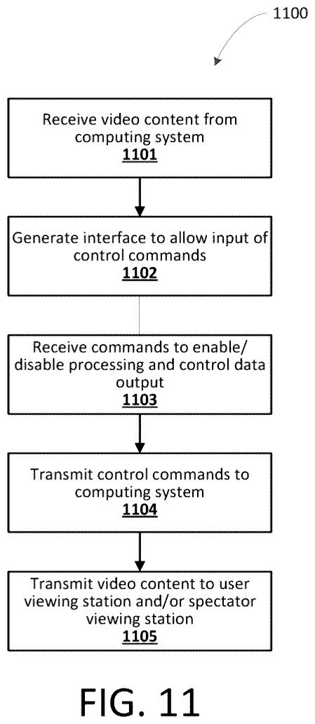

FIG. 11 illustrates a flow chart of operations 1100 which may be performed by an optional distribution unit 106, in some embodiments. As shown in block 1101, the distribution unit 106 may include means, such as a processor, communications interface, or the like, to receive one or more video content streams with associated data from a computing system 104. At block 1102, a distribution unit 106 may include means, such as a processor, memory, or the like for generating one or more interfaces, such as a central streaming portal, web site, or command and control portal, to allow for selection of one or more configurable content streams and system control. In some embodiments, a distribution unit 106 may provide means to allow the user to provide a personal identifier to uniquely identify the user. A user or session identifier, a target identifier, hit locations, and/or shot analytics may be stored in a storage device 105, linking a unique user and/or session with the hit locations and shot analytics. At block 1103, a distribution unit 106 may include means, such as a processor, memory, a display, or the like for receiving system control and data output commands from a user control viewing station 108. In some embodiments, the interface may provide for enabling/disabling the recognition module 141, enabling/disabling the display of detected hits, enabling/disabling hit analytics, manual selection of the bounds of the region of interest, enabling/disabling screenshot capture and save on detected hits, selection of video stream display, and so on. At block 1104, a distribution unit 106 may include means, such as a processor, memory, communication interface, or the like, for transmitting control commands to a computing system 104. At block 1105, a distribution unit 106 may include means, such as a processor, memory, communication interface, or the like, to cause the selected content stream with accompanying data to be transmitted to a user control viewing station 108 or viewing station 109 for playback. In some embodiments, a distribution unit 106 may provide means, such as a processor, memory, a display, or the like for receiving access requests from other entities, including law enforcement agencies or certification organizations. These other entities may access data, for example, in support of certification, recertification, advancement, qualification, or other similar qualifying events. Allowing certification organizations and other entities to access automatically recorded data for a particular user may streamline certification and qualification processes.

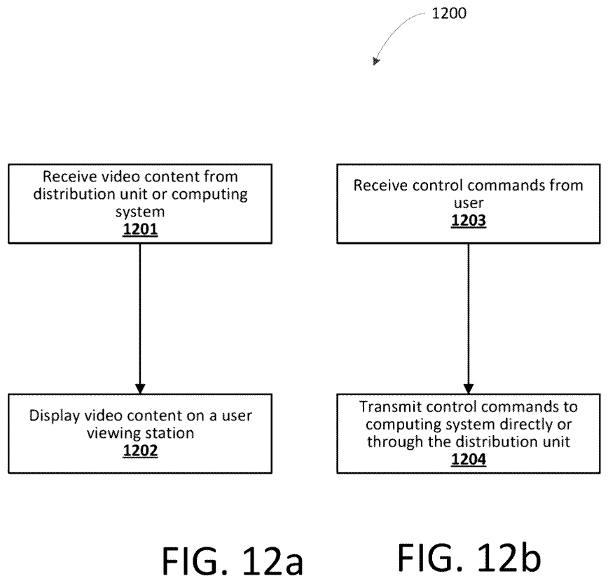

FIGS. 12a through 12b illustrate flow charts of operations which may be performed by a user control viewing station 108 in accordance with an example embodiment of the present invention.

FIG. 12a illustrates operations which may be performed by a user control viewing station 108 to provide video content to a user, in some embodiments. As shown in block 1201, the user control viewing station 108 may include means, such as a processor, communication interface, or the like, to receive one or more video content streams from a distribution unit 106 or a computing system 104. As shown in block 1202, a user control viewing station 108 may include means, such as a processor, communication interface, display, or the like, to display selected content on a user control viewing station 108. In some embodiments, for example, a user may view enhanced video content or a live stream on a computer monitor, laptop, phone, tablet, or the like by directly connecting to a computing system 104 or by connecting through a web interface. In some embodiments, utilization of a distribution unit 106 and a communication interface 107 may allow multiple users to view the content simultaneously.

FIG. 12b illustrates operations which may be performed by a user control viewing station 108 to provide system command and control to the end user, in some embodiments. As shown in block 1203, a user control viewing station 108 may include means, such as a processor, communication interface, hardware, mechanical buttons, a graphical user interface, or the like, to receive commands from a user. In some embodiments, a control panel 151 may be implemented as a user interface with selectable features, a separate device providing user selectable buttons (e.g., stream deck), and/or mechanical input (e.g., buttons, switches, etc.). As shown in block 1204, a user control viewing station 108 may include means, such as a processor, communication interface, or the like to transmit control commands to a computing system 104 through the distribution unit 106 or by direct communication to a computing system 104.

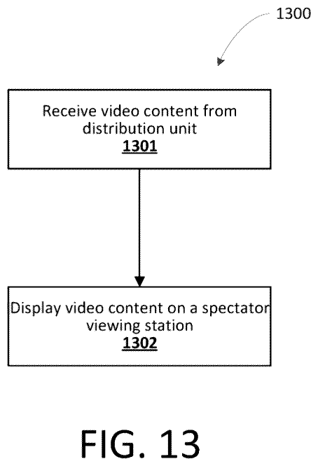

FIG. 13 illustrates a flow chart of operations which may be performed by a viewing station 109, in some embodiments. As shown in block 1301, a viewing station 109 may include means, such as a processor, communication interface, or the like, to receive one or more video content streams from the distribution unit 106 or directly from a computing system 104. As shown in block 1302, a viewing station 109 may include means, such as a processor, network interface, or the like, to display selected content on a viewing station 109. In the primary embodiment, for example, one or more spectators may access the stream of enhanced video content through a communication interface 107 and display live video content with hit location indicators and real-time analytics on a device capable of displaying video content such as a personal computer, laptop, tablet, or phone. In some embodiments, a viewing station 109 may provide a command and control interface allowing a user to select a specific stream of video content and toggle hit indicators as well as displayed analytics. In other embodiments, a viewing station 109 may provide means for receiving access requests from other entities, including law enforcement agencies or certification organizations, to access shot analytics for a user. These other entities may access this data, for example, in support of certification, recertification, advancement, qualification, or other similar qualifying events.

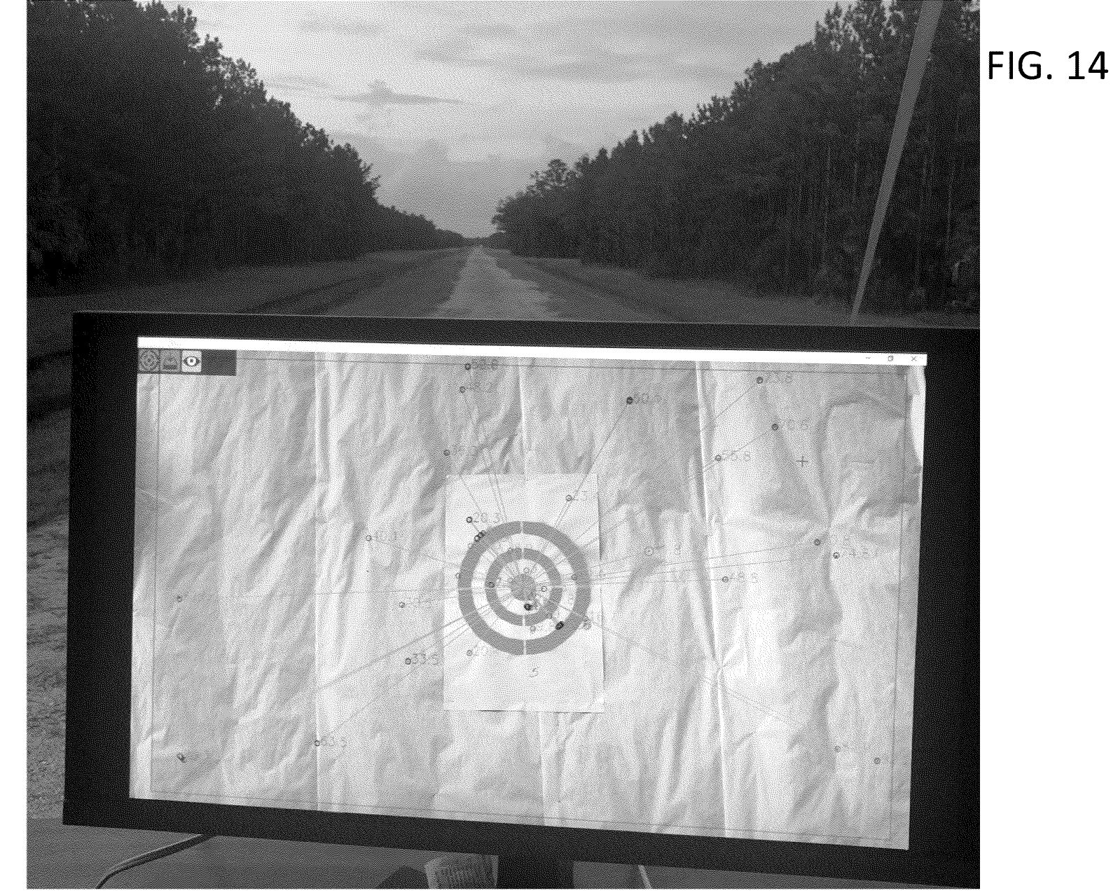

FIG. 14 illustrates an exemplary interface providing enhanced video content of a target 101 containing hit locations and other hit analytics, in accordance with an example embodiment of the present invention. As disclosed herein, a user control viewing station 108 and/or a viewing station 109 may include means, such as a processor, communication interface, a display, or the like, to display selected content. In some embodiments, for example, a user may view enhanced video content or a live stream on a computer monitor, laptop, phone, tablet, or the like. In some embodiments, a user control viewing station 108 and/or a viewing station 109 may receive enhanced video content by connecting to a computing system 104 directly or by accessing the stream of enhanced video content through a communication interface 107. In some embodiments, the enhanced video content may contain live video content with hit location indicators and other real-time analytics, such as the distance of the hit from the center of the target 101. In some embodiments, a user control viewing station 108 may provide an interface which allows for enabling/disabling the recognition module 141, enabling/disabling the display of detected hits, enabling/disabling hit analytics, manual selection of the bounds of the region of interest, enabling/disabling screenshot capture and save on detected hits, selection of video stream display, and so on. In still other embodiments, a viewing station 109 may provide a command and control interface allowing a user to select a specific stream of video content and toggle hit indicators as well as displayed analytics. In some embodiments, utilization of a distribution unit 106 and a communication interface 107 may allow multiple users to view the enhanced video content with accompanying hit locations and hit analytics simultaneously.

### CONCLUSION

Many modifications and other embodiments of the disclosure set forth herein will come to mind to one skilled in the art having the benefit of the teachings presented in the foregoing descriptions and the associated drawings. Therefore, it is to be understood that the disclosure is not to be limited to the specific embodiments disclosed and the modifications and other embodiments are intended to be included within the scope of the appended claims. Although specific terms are employed herein, they are used in a generic and descriptive sense only and not for purposes of limitation.

1. A system comprising:
at least one camera unit directed at a target and configured to capture a stream of video content, wherein the at least one camera unit comprises a transmitting unit configured to transmit the stream of video content;
a receiving unit configured to receive the stream of video content from the at least one camera unit;
a computing system configured to receive the one or more streams of video content from the one or more receiving units,
wherein the at least one computing system comprises:
a recognition module configured to identify a hit location of a projectile on the target through optical processing of the stream of video content;
a compute module, configured to compute analytics pertaining to the hit location of the projectile on the target;
a rendering module configured to generate enhanced video content,
wherein, the enhanced video content indicates the location of the hit and/or computed analytics within the stream of video content; and
a transmit module configured to transmit the enhanced video content for display on a display device; and
an enable mechanism configured to enable/disable the recognition module.

2. The system of claim 1 further comprising:
a distribution unit configured to receive the one or more streams of enhanced video content from the computing system and transmit the one or more streams of enhanced video content to at least one viewing station and/or user control viewing station via a communication interface.

3. The system of claim 2, wherein the user control viewing station comprises:
a user display device configured to display the one or more streams of enhanced video content; and
a control panel configured to allow control of the enhanced video content.

4. The system of claim 2, wherein the viewing station comprises a viewing display device configured to display the at least one stream of video content.

5. The system of claim 2, wherein the enable mechanism comprises at least one of a manual mechanism on the user control viewing station configured to enable/disable the recognition module in an instance in which the manual mechanism is engaged by a user and an automatic mechanism configured to enable/disable the recognition module through visual or auditory cues.

6. The system of claim 1, wherein the target comprises a target identifier capable of uniquely identifying the target.

7. The system of claim 6, wherein a user provides a user identifier capable of uniquely identifying the user.

8. The system of claim 7, wherein the target identifier, the user identifier, the hit location, and/or the computed analytics are stored in a storage device.

9. A method comprising:
capturing, by a camera unit, a stream of video content of a projectile hitting a target;
transmitting, by a transmitting unit, the stream of video content;
receiving, by a receiving unit, the stream of video content;
identifying, by a recognition module of a computing system, a hit location of the projectile on the target;
computing, by a compute module of the computing system, analytics pertaining to the hit location of the projectile;
transmitting the stream of video content, the hit location, and/or analytics for display on a display device; and
receiving from an enable mechanism, an indicator directing enable/disable of the recognition module.

10. The method of claim 9, further comprising: buffering the stream of video content, by the computing system, into a current frame and at least one previous frame; and comparing, by the recognition module, the hit location on the current frame with the same location on a previous frame of the at least one previous frames to detect change and confirm the hit location.

11. The method of claim 9, wherein identifying the hit location of the projectile on the target comprises identifying through optical processing of the stream of video content the hit location of the projectile at least based on the shape of the hit location.

12. The method of claim 9, further comprising identifying, by the recognition module, a target center.

13. The method of claim 12, further comprising computing, by the compute module, the distance from the hit location to the target center.

14. The method of claim 9, further comprising recording, by the computer system, the hit location in a hit progression sequence.

15. A computer program product for providing, via a user interface, visual indication of projectile hits, the computer program product comprising at least one non-transitory computer-readable storage medium having computer-executable program code instructions comprising program code instructions to:
buffer a stream of video content, received by a camera unit, of a projectile hitting a target, into a current frame and at least one previous frame;
perform image filtering to reduce noise on the current frame;
identify from the current frame a hit location of the projectile on the target;
identify a target center;
compute analytics pertaining to the hit location of the projectile;
provide an interface to a spectator for viewing the current frame, marked with the hit location and/or the analytics pertaining to the hit location of the projectile;
provide an interface to a user for viewing the current frame, marked with the hit location and/or the analytics pertaining to the hit location of the projectile; and
receive an indicator from an enable mechanism directing enable/disable of the recognition module.

16. The computer program product of claim 15, wherein the hit location of the projectile is identified at least in part based on the shape of the hit location.

17. The computer program product of claim 15, wherein the hit location is identified at least in part based on comparing the hit location on the current frame with the same location on a previous frame of the at least one previous frames to detect change and confirm a hit location.

18. The computer program product of claim 15, further configured to calculate the distance from the hit location to the target center.

19. The computer program product of claim 15, further configured to identify on the target, a target identifier, capable of uniquely identifying the target and store the target identifier, a user provided identifier capable of uniquely identify the user, the hit location, and/or the computed analytics in an accessible storage device.

20. The computer program product of claim 15, further configured to record one or more hit locations and calculate a shot grouping by computing the maximum distance between any two hit locations.
